(19) United States
(12) Patent Application Publication
(10) Pub. No.: US 2008/0294338 A1
(43) Pub. Date: Nov. 27, 2008

(54) Method of Mapping and Navigating Mobile Robot by Artificial Landmark and Local Coordinate

(76) Inventors: Nakju Doh, Daejon (KR); Won Pil Yu, Ulsan (KR); Sang Ik Na, Daejon (KR)

Correspondence Address: LADAS & PARRY LLP, 224 SOUTH MICHIGAN AVENUE, SUITE 1600, CHICAGO, IL, 60604, US

(21) Appl. No.: 12/091,994

(22) PCT Filed: Jul. 26, 2006
(86) PCT No.: PCT/KR2006/002933

§ 371 Date: Apr. 29, 2008

(30) Foreign Application Priority Data
Dec. 9, 2005 (KR) 10-2005-0120280
Feb. 6, 2006 (KR) 10-2006-0011198

(51) Int. Cl. B25J 9/16

(52) U.S. Cl. 701/209; 701/208; 901/1; 901/46

(57) ABSTRACT

A method of mapping and navigating a mobile robot by an artificial landmark and a local coordinate is provided. The method of creating a map includes: a) recognizing an artificial landmark in a target space and defining the recognized artificial landmark as a predetermined node; b) defining an adjacent artificial landmark as a destination node while traveling to the adjacent artificial landmark; c) defining the recognized artificial landmark as an origin of a local coordinate, defining a coordinate axis provided from the predetermined artificial landmark as a coordinate axis of the origin, obtaining and storing information about the predetermined node, the destination node, and an edge connecting the predetermined node and the destination node; and d) creating a map by storing information about edges between each of nodes to an adjacent node for all of the artificial landmarks through repeatedly performing the steps b) and c).

### TECHNICAL FIELD

The present invention relates to a method of mapping and navigating a space with a mobile robot, and more particularly, to a method of mapping and navigating a wide space with a mobile rotor having a mobile unit, using an artificial landmark and a local coordinate, which enables the mobile robot to smoothly navigate the space using the created map.

### BACKGROUND ART

There are many difficulties when a mobile robot creates a map for a wide space. The most difficulty among them is to express an entire space as a global coordinate. If a target space for creating a map is not so wide, it is not so difficult to express the target space as the global coordinate.

For example, it is not so difficult to express a first space A and a second space B in FIG. 1 as one global coordinate (X_{Global}, Y_{Global}). However, as a space for making a map increases, a position recognition error of the mobile robot increases too. Therefore, it is a very difficult work to make a map with a metric consistency for a wide target space.

For example, when it is assumed that the first space A is far away from a third space C in FIG. 1. position errors of the mobile robot with respect to the global coordinate are increased in proportion to a distance between the first space A and the third space C, and thus the mobile robot has a difficulty in creating a map with the metric consistency for the first space A and the third space C. In order to overcome such a shortcoming, a conventional method of scaling using a high-performance and expensive laser scanner was introduced in an article by M. Bosse, P. Newman, J. Leonard, and S. Teller, entitled “SLAM in Large-scale cyclic environments using the atlas frame” in International Journal of Robotics Research, vol. 23, pp. 1113-1140, 2004. However, the conventional method requires a post-processing that takes about 2 hours and 30 minutes to do.

In order to commercialize such mobile robots, it is not preferable to use high-performance and expensive equipments and to spend such a long time to create a map.

Meanwhile, a conventional technology for creating a map for a closed area is disclosed in Korean Patent Laid-open Publication No. 10-2004-0087171 entitled “MAPPING METHOD BY PATH TRACE FOR MOBILE ROBOT.” The conventional technology teaches a method of mapping in a closed area by tracing a path of a mobile robot. However, the conventional technology uses a mobile robot having a rechargeable battery.

However, since the above conventional technologies for mapping have a target space as a closed space which is not so wide, they are confronted with the aforementioned difficulties. Although there have been many researches on a method of creating a map for a wide space, most of researches in the academic world related to the improvement of the metric consistency using a high expensive sensor, which is a major factor in increasing a manufacturing cost.

### DISCLOSURE OF INVENTION

### Technical Problem

It is, therefore, an object of the present invention to provide a method of mapping a target space with a mobile robot using an artificial landmark and a local coordinate, which allows the mobile robot to create the map in a short time using a low-price sensor and a local coordinate created through an artificial landmark recognition in a current position of the robot even for a wide space.

It is another object of the present invention to provide a method of navigating a mobile robot, which allows the mobile robot provided with a low-price sensor to naturally travel based on the map crated using a local coordinate created through the artificial landmark recognition.

### Technical Solution

To achieve these objects and other advantages and in accordance with the purpose of the invention, as embodied and broadly described herein, there is provided a method of mapping a target space with a mobile robot using artificial landmarks and a local coordinate. The target space is divided into a moving zone including a traveling path of the robot and a working zone where the robot performs an operation, and the moving zone is comprised of nodes corresponding to positions of the artificial landmarks and edges connecting the nodes. The mapping is performed by separating a topological map abstracted through a graph connecting the nodes and the edges.

According to another aspect of the present invention, there is provided a method of mapping a target space with a mobile robot using artificial landmarks and a local coordinate. The target space includes a moving zone having a traveling path of a robot and a working zone where a robot performs operations. The mapping is performed by inputting node information corresponding to the artificial landmarks and edge information connecting the nodes into a robot and creating a local coordinate through an artificial landmark recognition at a current position of the robot.

According to a further aspect of the present invention, there is provided a method of navigating a target space with a mobile robot using artificial landmarks and a local coordinate. The target space includes a moving zone having a traveling path of a robot and a working zone where a robot performs operations. As node information corresponding to the artificial landmarks and edge information connecting the nodes are inputted into a robot, the robot moves along the edge using the local coordinate created through a recognition of the artificial landmark at a current position of the robot on a topological map created by abstracting an entire map of the target space through a graph connecting the nodes and the edges.

### ADVANTAGEOUS EFFECTS

According to the present invention, a method of mapping and navigating a space with a mobile robot using an artificial landmark and a local coordinate has the following advantages.

First, the inventive method reduces the number of the artificial landmarks to be used. The conventional approach which in general represents the entire space in a grid map needs lots of artificial landmarks to cover all the space, but the inventive method devides a large space into a moving zone and a working zone, and the moving zone which constitutes a large portion of the space needs relatively low number of artificial landmarks compared to the working zone. Thus, the inventive method enables mapping with a quite low number of artificial landmarks than the conventional approach.

Secondly, the inventive method uses a topological map and a grid map together in a wide space. Thus, a memory size required for the mapping is reduced and the robot is allowed to create a path in real time. Generally, it is difficult to create a path in real time using the grid map if the grid map is created for a wide space. However, the inventive method applies the grid map only to the working zone, thereby enabling a path to be created in real time.

Thirdly, the inventive method enables a rapid mapping with sufficient information necessary for the moving of the mobile robot without using a high price sensor by maintaining the topological consistency instead of the metric consistency.

Fourthly, the inventive method enables a unartitifical movement of the mobile robot by in advance storing types of edges.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram for describing a difficulty of a metric consistency;

FIG. 2 is a block diagram for describing a global coordinate and a local coordinate;

FIG. 3 is a block diagram for illustrating a moving zone with artificial landmarks disposed thereto;

FIG. 4 is a diagram for illustrating map information expressed for one node;

FIG. 5 is a block diagram illustrating a topological map having nodes connected through an edge;

FIG. 6 is a block diagram illustrating a topological map having nodes connected through an extended edge according to the present invention;

FIG. 7 shows a map created by overlapping a working zone and a moving zone under an assumption of no position error according to the present invention;

FIG. 8 shows a traveling path made by a robot with no edge information; and

FIG. 9 shows a traveling path made by a robot with edge information.

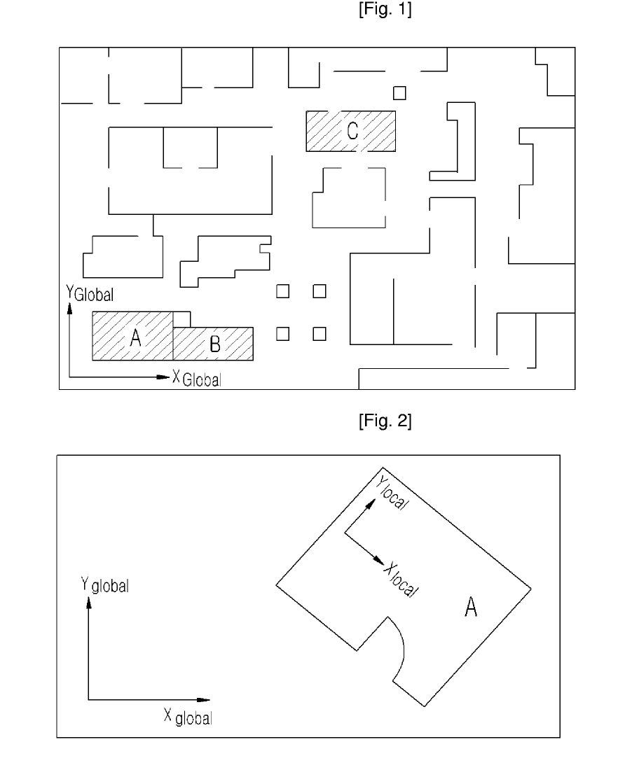

### BEST MODE FOR CARRYING OUT THE INVENTION

Hereinafter, terms used throughout the present specification will be described.

Coordinate Used as Reference to Create Map

The coordinate is classified into a global coordinate and a local coordinate in the present invention. The global coordinate is a reference for an entire map. The local coordinate is a coordinate generated by recognizing an artificial landmark at a current position of a robot.

For example, only one global coordinate is given for the entire map. On the contrary, a plurality of local coordinates may be given for one map because the local coordinates are created within a local space recognized by the mobile robot, as shown in FIG. 2.

Node and Edge in Topological Map

In the topological map, a node denotes a specific space and an edge denotes a road connected to the node. The topological map is a map abstracted through a graph formed of the nodes and the edges.

Metric Consistency and Topological Consistency

The metric consistency means that all local spaces of a map are consistently expressed based on a global coordinate. That is, a map with the metric consistency describes all local spaces based on the global coordinate and all of local spaces in the map have relations each other.

The topological consistency denotes that the topological map directly relates to a graph. That is, it can be said that the map maintains the topological consistency if edges connected to specific nodes are matched with a real space of the topological map. Especially, a map maintaining only the topological consistency does not require the global coordinate because the characteristics of the graph can be maintained without describing specific nodes or edges based on the global coordinate.

Hereinafter, a method of mapping and moving in a space with a mobile robot using an artificial landmark and a global coordinate according to the present invention will be described in detail with reference to the accompanying drawings.

The present invention divides a target space for creating a map into two zones: a moving zone and a working zone.

In the moving zone, a main operation of the mobile robot is to move to a specific node on a topological map. The moving zone is comprised of nodes and edges, and the robot may perform a operation requiring a relatively small working space at several nodes. For example, a space front of a specific person's desk may be defined as a node and in this case the robot may perform a operation to leave a letter on the desk within a small radius from a node. Generally, a hall way and a junction may be classified as the moving zone due to the characteristics of the moving zone.

The working zone may be defined as a wider space where the robot performs various operations. Also, the working zone may be defined as all other spaces excepting the moving zone. For example, the robot performs operations for cleaning or frequently travels within the working zone. An office or an apartment may be classified as the working zone due to the characteristics of the working zone. Such a classification based on the working characteristics of a space is originally introduced in this invention.

Method of Creating Map for Moving Zone of Robot

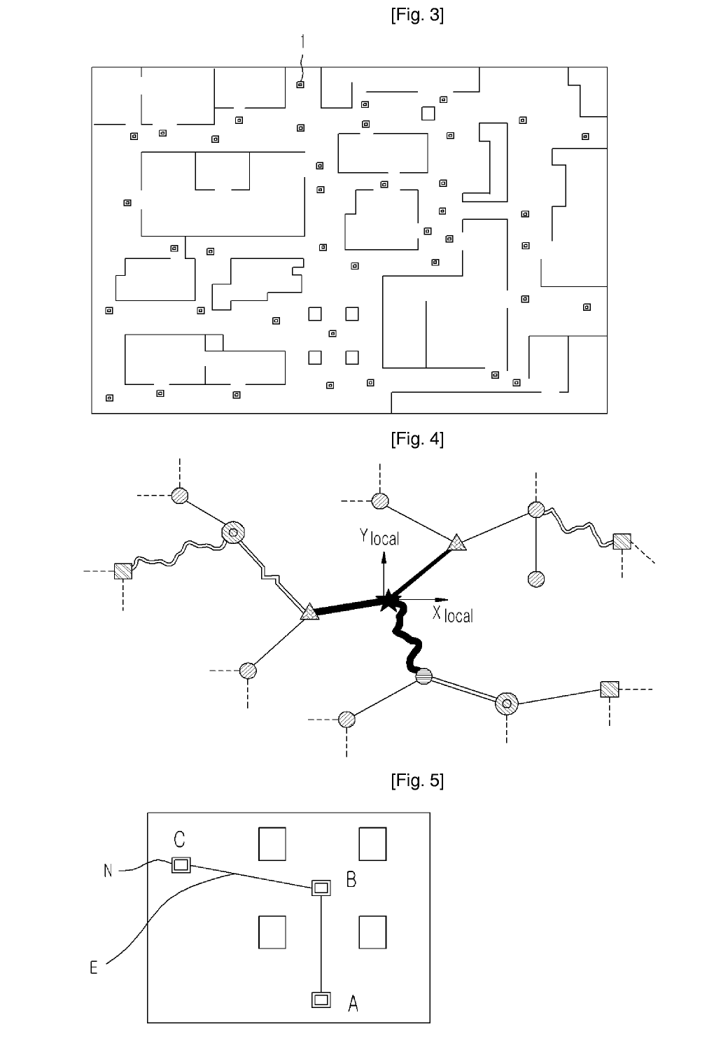

Since the moving zone is expressed as a topological graph, nodes and edges must be defined. The most practical method of defining nodes is that a user assigns a few predetermined places as nodes. In order to define nodes at all kinds of environments, an artificial landmark 1 is attached on an object in a target space to be defined as a node in an entire moving zone as shown in FIG. 3.

If the nodes are defined, the following information related to each node is inputted as shown in FIG. 4.
position of node related to a recognized artificial landmark in a global coordinate
Shape and length of each edge
ID of node reached along edge
The number of edges connected to nodes

The information on the position of node related to the recognized artificial landmark in the global coordinate can be easily obtained through recognizing the artificial landmark and extracting a local coordinate using the recognized artificial landmark. For example, if a user controls a robot to store a current position of the robot as a node when the robot is in a range of a recognizable artificial landmark, the robot stores a relative position value based on the artificial landmark as a position of a node.

The information on the shape and length of each edge can be obtained by storing position information in a local coordinate transmitted from a plurality of sensors or wheels of the robot while manually or automatically moving the robot from node to another.

The information on the ID of node reached along an edge can be obtained through a recognized artificial landmark at the moment the robot finishes the traveling of one edge.

The information on the number of edges connected to a node can be easily calculated when all of the above information are obtained for one node. For example, the information on the number of edges is obtained by increasing the number of edges connected to the node whenever the information about the shape and length of the edge is added.

It should be noted that the information on the position of the node or the shape of the edge is described based on the local coordinate of the node. The edges are defined based on real connections of positions in the topological connection. However, an edge may directly connect two nodes although the two nodes are connected by passing through one or more nodes in the real space. For example, a connection made by an edge E based on a topological map is illustrated in FIG. 5. When the robot wishes to travel from a node (N) A to a node (N) C according to this topological map shown in FIG. 5, the robot must be via a node (N) B so as to reach the node (N) C.

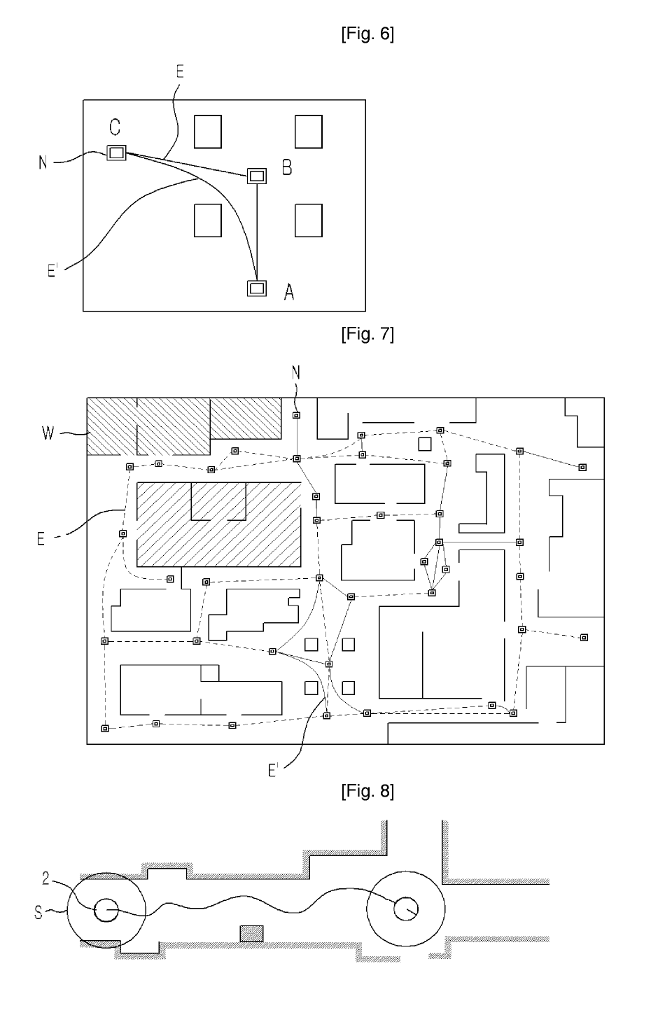

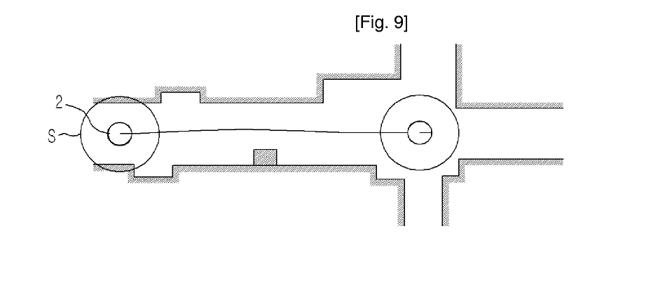

However, it is also possible to make an edge E′ as shown in FIG. 6, which directly connects the node (N) A to the node (N) C according to the present invention. A similar conventional technology was introduced in an article by Nakju Lett Doh, Kyoungmin Lee, Jinwook Huh, Namyoung Cho, Jung-Suk Lee, and Wan Kyun Chung, entitled “A Robust Localization Algorithm in Topological Maps with Dynamics,” in IEEE International Conference on Robotics and Automation, pp. 4372-4377, 2005. The conventional technology connects nodes only when an angle of a robot entering to a node is similar to an angle of a robot exiting from the node. However, the present invention enables a user to extend or connect an edge whenever necessary regardless of the angle of the robot entering and exiting.

As described above, if information related to all of nodes are inputted, the mapping for the moving zone of the robot is completed. Such a mapping are performed with respect to the local coordinates of the respective nodes. Therefore, the mapping method according to the present invention does not require a post-processing for relations between nodes in the global coordinates. Therefore, it is possible to quickly create the map with sufficient information for moving the robot while using only low-cost sensors.

Method of Creating Map for Working Zone for Robot

In the working zone, the robot performs various operations in a wide space and all of local spaces are connected one another. Therefore, it is more convenient to recognize the entire working zone as a one node. In order to perform cleaning jobs by a robot, the robot must be allowed to recognize a current position based on a local coordinate anywhere in the working zone. Therefore, artificial landmarks must be sufficiently disposed throughout the entire working zone. As described above, if the entire working zone is recognized as a single node and the sufficient artificial landmarks are disposed throughout the working zone, the robot is allowed to recognize the arrival at the working zone automatically.

The major feature of the present invention is to create the map using the local coordinate of the working zone. The working zone is generally expressed in a grid map, and a distance sensor such as a laser scanner and a supersonic sensor is used to create the grip map. Since the method of creating the grip map are well known to those skilled in the art, a detail description thereof will be omitted. As an example, the method of creating the grip map is disclosed in an article by X. Zezhong et. al., entitled “Scan matching based on CLS relationships” in IEEE/RJS international conference on intelligent system and signal processing, 2003, an article by A. Censi et. al., “Scan matching in the house domain”, IEEE international conference on robotics and automation, 2005, and an article by Lee, Sejin et. al., entitled “A new feature map building from grid association”, International conference on ubiquitous robots and ambient intelligence, 2005.

Since the maps for the moving zone and the working zone are created based on the local coordinates, it is difficult to express the working zone and the moving zone at the same time. However, if the map is created by overlapping the moving zone map and the working zone map while ignoring position errors of a robot, a map shown in FIG. 7 may be obtained. In FIG. 7, a hatched box W denotes a working zone, a rectangular dot N denotes a node, and a dotted line E denotes an edge.

Method for Traveling Robot

A method for navigating a robot using a map shown in FIG. 7 will be described below.

A destination of the robot is described in two methods.

A first method teaches only a destination node to a robot. The first method is performed for a simple travel operation between two nodes or a moving operation within a short radius of a node.

A second method teaches the destination node with a predetermined command within a local coordinate of the destination node to a robot. That is, the second is used when a robot must travel to a working zone and perform operations for accomplishing the command. In this case, the node of the working zone and a coordinate point for a local coordinate in the working zone are assigned as a destination point. After the destination point is set, the robot travels to a node nearest to a current position. After traveling, the robot makes a plan to reach the destination node from the current node. Then, the robot travels nodes to nodes along edges stored according to the corresponding nodes, and the robot recognizes the arrival at the nodes through recognizing the artificial landmarks.

As described above, the robot is allowed to more naturally move by previously storing types of edges according to the nodes. For example, it is assumed that a space sensible by a sensor of a robot is limited by a circle (S) when a robot 2 travels from a node to another node along the edge as shown in FIG. 8. Under this assumption, if the edge information is not known to the robot 2, the robot 2 travels along most secured center points of a sensed space. In this case, the robot 2 travels in an unnatural zigzag fashion. However, if the edge type information is previously inputted, the robot 2 can naturally move although the robot 2 uses a short sensing range sensor. Although the robot uses such a long sensing range sensor such as a laser scanner, it is not easy to estimate a most effective and natural traveling path among all of long edges. Therefore, it is preferable to previously store the edge type information.

Hereinafter, three operating examples of the method of moving the robot according to the present invention will be described.

As a first example, the moving operation for simple traveling within a moving zone will be described below.

A robot receives a command to travel to a predetermined node or a nearest node in a moving zone. In theses case, the major operation of the robot is to move to the predetermined node.

The robot already has the information about the local coordinates of nodes, the IDs of nodes and the length of edges connecting nodes. That is, the robot has a graph for an entire map with length information of edges. If the graph is given to the robot, it is possible to extract a shortest path between nodes using A* or Dijkstra algorithm. The shortest path includes information about IDs of nodes to pass through and numbers of edges to move from each node to next node. The robot moves to the nearest node based on the above-mentioned information. Then, the robot rotates to an edge direction for traveling the next node. After rotating, the robot travels along the shape of the corresponding edge stored in the map. When the robot arrives around the node, the robot can recognize the node. That is, the robot recognizes the arrival at the node through the recognition. The robot moves in the moving zone by repeatedly performing such operations until the robot arrives at the destination node.

As a second example, the moving operation of the robot in the working zone will be described.

In the working zone, there are sufficient artificial landmarks disposed to recognize the entire working zone. Therefore, one of nodes in the working zone is defined as a representative node and the entire working zone is described based on a local coordinate of the representative node. The traveling of the robot is estimated by a general A* algorithm.

As a third example, the moving operation of the robot in the moving zone and the working zone will be described.

In a view of planning a traveling path, the working zone is treated as one node. Therefore, the planning of the traveling path is not badly influenced by the working zone. Since the working zone is recognized as a node, there is an edge created between a node of the moving zone and a node of the working zone. When a robot travels on such an edge, the robot can recognize whether the next node is the working zone or not. Therefore, if the robot finds the ID of the node corresponding to the working zone, the robot travels according to the method of moving in the working zone. In the case of the moving zone, on the contrary, the robot recognizes that the next node is in the moving zone and the robot travels according to the method of moving in the moving zone.

It will be apparent to those skilled in the art that various modifications and variations can be made in the present invention. Thus, it is intended that the present invention covers the modifications and variations of this invention provided they come within the scope of the appended claims and their equivalents.

1. A method of mapping a target space with a mobile robot using a plurality of artificial landmarks and a local coordinate, the method comprising the steps of:
a) at the mobile robot, recognizing one of the plurality of artificial landmarks attached on objects in the target space for the mapping, and defining the recognized artificial landmark as a predetermined node;
b) defining an adjacent artificial landmark as a destination node while traveling from the predetermined node to the adjacent artificial landmark;
c) defining the artificial landmark recognized in the predetermined node or any point around the artificial landmark as an origin of a local coordinate, and defining a coordinate axis provided from the predetermined artificial landmark or a specific form relatively represented with respect to the predetermined artificial landmark as a coordinate axis of the origin, to store information on the predetermined node and the destination node, and information on an edge connecting the predetermined node and the destination node; and
d) creating the map by storing information on the adjacent nodes and edges between the respective nodes for all of the artificial landmarks through repeatedly performing the steps b) and c).

2. The method of claim 1, wherein the map is created by classifying the target space into a moving zone including a traveling path of the robot and a working zone where the robot performs predetermined operations.

3. The method of claim 1 or 2, wherein the stored information about the nodes and the edges for the moving zone and the working zone includes information about a position of a node based on a local coordinate of a recognized artificial landmark, a shape and a length of each edge, an ID of a node reached along an edge, and the number of edges connected to a node.

4. The method of claim 3, wherein the information about the shape and the length of each edge are obtained through position information of a local coordinate obtained through wheels or sensors while the robot travels from one node to another node, manually or automatically.

5. The method of claim 3, wherein the information about the ID of the node reached along the edge is obtained through an artificial landmark recognized at the moment that the robot finishes the traveling of one edge.

6. The method of claim 2, wherein the working zone is recognized as a node.

7. The method of claim 1, wherein the edge is described based on a topological connection type in a real space, and the edge directly connects a node to a destination node when the robot travels from the node to the destination node by passing through one or more nodes.

8. The method of claim 2, wherein the working zone is expressed as a grid map.

9. The method of claim 8, wherein the grid map is formed using a distance sensor including a laser scanner and an ultrasonic sensor.

10. A method of moving a mobile robot using an artificial landmark and a local coordinate, comprising the steps of:
a) defining a predetermined point around an artificial landmark as a node for a plurality of artificial landmarks attached at a target space for creating a map, defining the artificial landmark or a predetermined point around the artificial landmark as an origin of a local coordinate, defining a coordinate axis provided from the artificial landmark or a predetermined shape expressed comparatively for the artificial landmark as a coordinate axis of the origin, and storing information about a node, an adjacent node and edge between the node and the adjacent node in the robot;
b) at the robot, traveling from a current position to a nearest adjacent node in response to a command of moving to a destination node;
c) planning a path from the adjacent node to the destination node using the information about the nodes and the edge while traveling to the nearest adjacent node; and
d) traveling according to the information about the edge between the nodes.

11. The method of claim 10, wherein the target space is classified into a moving zone including a traveling path of the robot and a working zone where the robot performs operations.

12. The method of claim 11, wherein a node in the working zone and a coordinate point for a local coordinate in the working zone are assigned as a target point when the robot travels into the working zone and performs operations.
